(19) United States
(12) Patent Application Publication
(10) Pub. No.: US 2008/0183624 A1
(43) Pub. Date: Jul. 31, 2008

(54) PROTECTING PRESENTATIONS AND BINDING PRESENTATION ELEMENTS TO THE PRESENTATION

(75) Inventors: Alexandre Grigorovitch, Redmond, WA (US); James M. Alkove, Woodinville, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/669,274

(22) Filed: Jan. 31, 2007

(51) Int. Cl. H04L 9/00

(52) U.S. Cl. 705/51

(57) ABSTRACT

The claimed subject matter provides a system and/or a method that facilitates ensuring media integrity utilizing a root license and a leaf license. An interface component can receive at least one of media, content, data, or presentation with at least one element. A license component can associate a root license to the at least one of media, content, data, or presentation and a leaf license to at least one element, the leaf license is bound to the root license to ensure the at least one of media, content, data, or presentation and the at least one element include license protection.

### BACKGROUND

Traditionally, increasing advances in computer technology (e.g., microprocessor speed, memory capacity, data transfer bandwidth, software functionality, and the like) have generally contributed to increased computer application in various content distribution industries. Ever more powerful server systems, which are often configured as an array of servers, are generally provided to service requests originating from external sources such as the World Wide Web, for example. As local Intranet systems have become more sophisticated thereby requiring servicing of larger network loads and related applications, peer-to-peer file sharing and piracy over the Internet have grown accordingly as well. For example, today breaches of copyright law can be readily performed because of the ease with which digital files can be copied and transmitted. As such, content protection is of the utmost concern for content owners and distributors. In general, Digital Rights Management (DRM) can entail challenges for content communities in the current digital age.

Furthermore, technological advances in digital media players have created a new market channel for distribution of copyrighted content (e.g. music, video, pictures) to users. For example, a user can download and/or share (e.g., transfer) digital content via the Internet. Oftentimes, this download and/or transferred content can violate copyright laws and rights of the owner of the work. DRM is a mechanism for protecting the copyrights of digital content that is distributed over the Internet. A DRM system can also include the accounting for paying royalties to the authors of the material. For example, in the music industry, a typical DRM system can provide a container format that includes album and track titles along with a set of rules that can enforce copyright compliance. Accordingly, software and hardware media players should support the rules order to play back the copyrighted material.

Typically, in systems involving digital content distribution by service providers, there exists a one to one relationship (e.g., single user, single computer) between content consumer and the service provider, wherein the enablement of protected content is coupled to a single computer or media reader device. Such approach, although beneficial in certain schemes for avoiding unauthorized copying, has typically had other associated disadvantages. For example, cumbersome requirements are typically imposed for remembering, and then entering, the password when the media is provided in a second computer or reader, e.g., there is no provision for the media itself to provide, to a computer or reader, information regarding previous content enablement. In particular, when protection codes or keys are established and stored by a media fabricator (or the fabricator of a media player or host computer), or otherwise provided prior to distribution of content to a customer, the system is typically relatively inflexible, provides the potential for using a copy of the code or key to access multiple media, and presents a potential for interception of enabling keys or codes.

Such traditional techniques and/or approaches involving DRM impose certain undesirable restraints on how the content is distributed. For example, in traditional DRM techniques and/or mechanisms, payment (or a contract or commitment to make payment) is obtained at the time of distribution. One adverse consequence of such system is that the payment typically must be an all-or-nothing payment (e.g., payment for all content) even though a customer, client, and/or user may wish to have only a portion of such content. Moreover, difficulties with conventional DRM techniques arise with packaging portions of elements to create a presentation, wherein the presentation includes a single license. This typical one-to-one ratio of DRM techniques limits abilities involving a mix-and-match aspect for media and/or content. Furthermore, current DRM systems require content providers to package content into a single file in order to ensure that different pieces of content are consumed as a single block. Packaging can be an expensive operation which can consume a lot of CPU/Disk resources.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate ensuring protection for a portion of data utilizing a root license and at least one leaf license. A license component can receive data from an interface component to create protected data/media with at least a root license and a leaf license. The data received can be most any suitable data having at least one element, wherein the data can be related to media, content, presentations, audio, video, etc. The element can be, for instance, a portion of audio, a portion of video, a graphic, a portion of a text, a portion of an application, a portion of data related to a presentation, a portion of a presentation, a portion of a packaged media, etc. The license component can associate a leaf license to at least one element and bind such leaf license to a root license that is associated to the data. In addition, the license component can incorporate a policy within at least one of the root license and/or the leaf license.

In accordance with one aspect of the subject innovation, the license component can receive data to be protected via a content resource. The content resource can identify portions of data that can be packaged together, where such data can include various elements. The content resource can select portions of elements that can be packaged by the license component to create protected data, wherein such protected data can have a root license and corresponding elements can include bound leaf licenses. The content resource can be a content provider, a third-party, a service, a third-party service, a vendor, a manufacturer, a content-maker, a company, a web-service, a website, a database, an email, a data store, a local service, a remote party, most any suitable entity that can provide a portion of at least one of media, presentation, content, etc., an advertising agency, a media company, and/or most any suitable technique that can identify portions of data that can be protected.

In accordance with another aspect of the claimed subject matter, the license component can utilize a media service to facilitate distributing the generated protected data, media, content, presentations, etc. The media service can deliver the data, media, content, presentations, etc. protected by the license component to most any suitable. It is to be appreciated that the media service can allow access to the protected data to allow a client to utilize such protected data based on an incorporated policy. In other aspects of the claimed subject matter, methods are provided that facilitates creating media with verified licensed protection enabled by at least one leaf license bound to a root license.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates ensuring protection for a portion of media utilizing a root license and at least one leaf license.

FIG. 2 illustrates a block diagram of an exemplary system that facilitates creating media with verified licensed protection enabled by at least one leaf license bound to a root license.

FIG. 3 illustrates a block diagram of an exemplary system that facilitates binding a leaf license to a root license for a presentation and respective element of such presentation.

FIG. 4 illustrates a block diagram of an exemplary system that facilitates creating protected media presentations with elements utilizing a root license and a bound leaf license.

FIG. 5 illustrates a block diagram of an exemplary system that facilitates employing a media service to provide protected media to a client.

FIG. 6 illustrates a block diagram of an exemplary system that facilitates ensuring protection for a portion of media utilizing a root license and at least one leaf license.

FIG. 7 illustrates a block diagram of a presentation, media, content, data, etc. with an element that provides licensing protection employing a root license and a bound leaf license.

FIG. 8 illustrates an exemplary methodology for ensuring protection for a portion of media utilizing a root license and at least one leaf license.

FIG. 9 illustrates an exemplary methodology for generating universal licensed media with a leaf license bound to a root license.

FIG. 10 illustrates an exemplary methodology that facilitates utilizing a portion of protected media having a root license and at least one leaf license.

FIG. 11 illustrates an exemplary networking environment, wherein the novel aspects of the claimed subject matter can be employed.

FIG. 12 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “service,” “resource,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD). . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

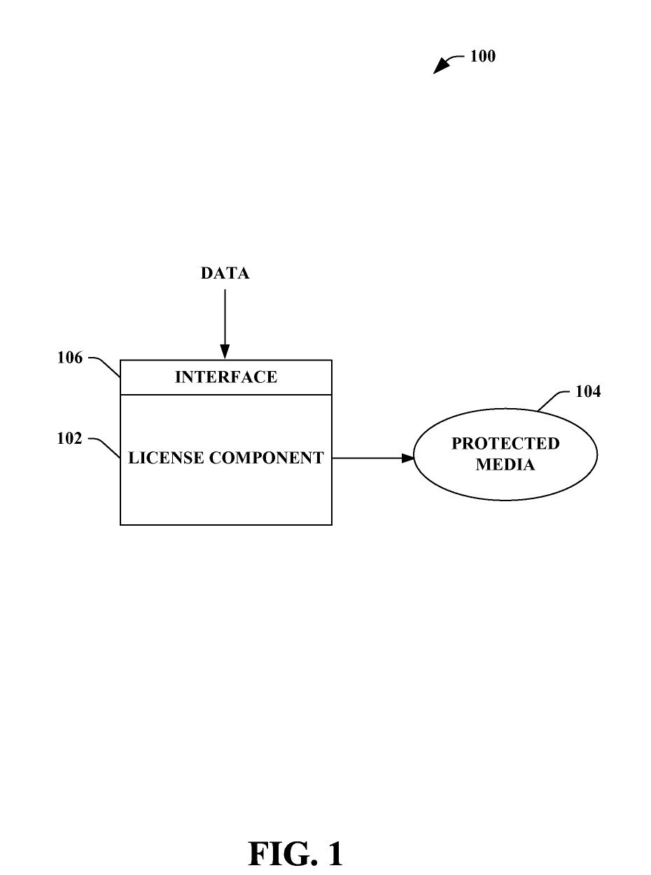

Now turning to the figures, FIG. 1 illustrates a system 100 that facilitates ensuring protection for a portion of media utilizing a root license and at least one leaf license. A system 100 can include a license component 102 that can receive data via an interface component 106, wherein the license component 102 can create protected media 104 utilizing a root license and at least one leaf license that is bound therewith. In particular, the interface component 106 can receive most any suitable data related to media, content, and/or presentation. For instance, the interface component 106 can receive media, content, presentation, data, etc. such that the license component 102 can create protected media 104. The protected media 104 can include a root license associated with the media, presentation, content, data, etc.

Moreover, the media, presentation, content, data, etc. can include at least one element, wherein the element (e.g., a portion of audio, a portion of video, a graphic, a portion of a text, a portion of an application, a portion of data related to a presentation, a portion of a presentation, a portion of a packaged media, etc.) can include a corresponding leaf license that is bound to the root license. In other words, the license component 102 can associated a leaf license to each element of media, presentation, content, data, etc. and such entireties of the media, presentation, content, data, etc. can be bound to a root license. Thus, the media, presentation, content, data, etc. can be licensed protected to ensure data integrity. It is to be appreciated that the format of the media, content, presentation, data, elements, etc. can be most any suitable format and the subject innovation is not to be limited on a specific file format.

For instance, a media, presentation, content, data, etc. can be a video. The video can include various elements such as a first element related to an advertisement video, a second element related to a preview video, and a third element related to a feature video. It is to be appreciated that the elements of the video can be licensed content to which protection is desired. The license component 102 can generate a root license for the video and corresponding elements. This particular root license can enforce most any suitable restrictions associated with the video. Moreover, each element can include a respective leaf license (e.g. enforcing most any suitable restriction associated with the element) that can be bound to the root license.

Furthermore, the system 100 can be implemented to facilitate creating the protected media 104 with numerous protected elements (if necessary based on the protection needed for the element) that can be mixed and matched. Conventional techniques and/or mechanisms typically invoke a one-to-one license ratio for presentations, media, content, data, etc. and respective elements. Based on the one-to-one ratio, the traditional techniques and/or mechanisms do not provide license protection for individual elements associated with the presentations, media, content, data, etc. In other words, conventional strategies include packaging the media and respective elements with a single license. In such manner, the media, content, data, presentation, etc. and respective elements is difficult to package and protect on a mix and match basis.

In another example, a content/presentation can include 30 seconds of advertising video followed by a 5 minute movie clip. A company can ensure that a user plays the advertising video on a normal speed (e.g., enforcing a restriction based on a license) before playing the movie clip. In other words, the user should not be able to skip through the advertising (e.g. fast forward, etc.). The system 100 can generate a root license for the presentation/content, wherein each element (e.g., 30 second advertising video, 5 minute movie clip, etc.) can include a leaf license that is bound to the root license. Thus, the entirety of the content/presentation and respective elements can be protected based on the appropriate licenses.

The system 100 utilizes a root license and/or a leaf license in order to allow a content provider to create complex presentations while avoiding repackaging for the elements which are included into the presentation. For example, a content provider can have a library of elements audio/video (e.g. A1, A2, . . . Aₙ, where N is a positive integer) ready to be delivered. The content provider can generate a complex presentation which contains any 2 elements (e.g., Ai, Aj), create a root license for the presentation, bind licenses for Ai and Aj to the root license, and deliver such package to the client.

On the client side, a client application can receive licenses for Ai and Aj, but may be not of user without the root license. A user might have many DRM aware applications installed on a machine. Some application may be able to play individual parts of the presentation (e.g., Ai), and some might understand how to play complex presentations (Ai, Aj). Both types of applications are valid. If licenses for Ai and Aj are independent, a user might try to use an application to playback a single portion of Ai of a complex presentation and by doing this violate policies defined by the content provider. The system 100 can define compliance rules which applications must follow in order to access DRM protected content. If an application does not follow the rules, it can be revoked by the DRM system (e.g., system 100). In this example, the application can follow the rules and may not be revoked; however, a user can use a disparate application to violate the policy. By implementing the root and leaf license policy, this problem is alleviated. Since both Ai and Aj are bound to the root license, the application has to understand complex presentation in order to access individual elements. Therefore, the disparate application may not be able to access individual elements of the complex presentation.

In addition, the system 100 can include any suitable and/or necessary interface component 106 (herein referred to as “interface 106”), which provides various adapters, connectors, channels, communication paths, etc. to integrate the license component 102 into virtually any operating and/or database system(s) and/or with one another. In addition, the interface component 106 can provide various adapters, connectors, channels, communication paths, etc., that provide for interaction with the license component 102, the protected media 104, a portion of media, a presentation, a license, a root license, a leaf license, and/or any other component, data and the like associated with the system 100.

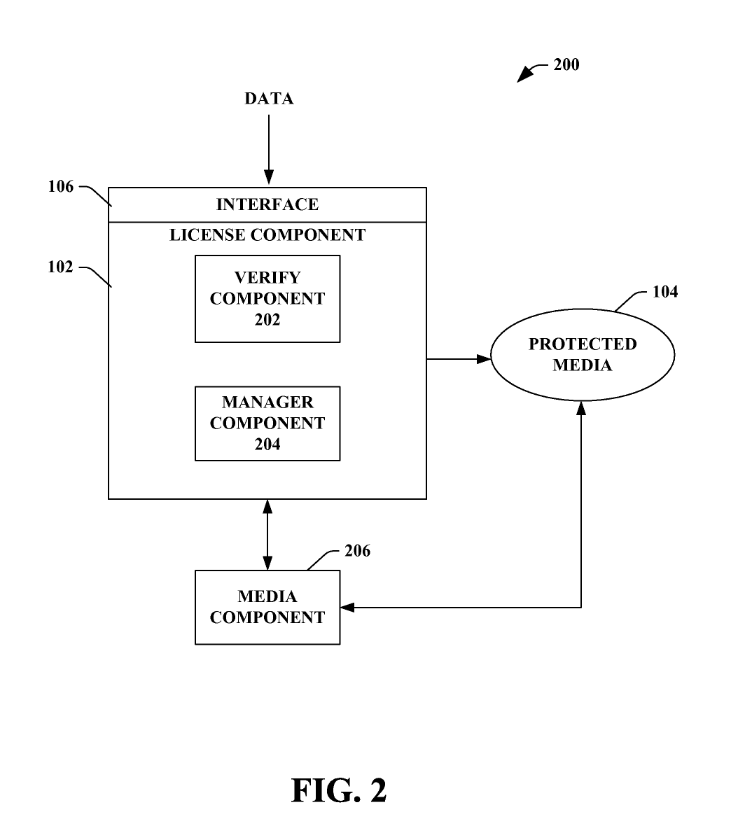

FIG. 2 illustrates a system 200 that facilitates creating media with verified licensed protection enabled by at least one leaf license bound to a root license. The system 200 can include the license component 102 that can generate a root license with bound leaf license(s) for a content/presentation/media/data and related element(s) respectively. Specifically, the interface component 106 can receive most any suitable media, content, presentation, data, etc. to allow the license component 102 to provide protected media 104. By generating the media/presentation/content/data with a root license and a bound leaf license for included elements, the license component 102 can provide the protected media 104.

The license component 102 can include a verify component 202 that can verify whether data received via the interface 106 entails a particular license. The verify component 202 can implement redundancy-check in order to identify which portions of received data requires license protection and which portions are not to be protected. For example, particular portions of data may or may not require license(s) in order to be utilized by a media component 206 (discussed in more detail infra). The verify component 202 can further provide monitoring of a complete package of media, presentation, content, data, etc. to ensure the appropriate and/or intended elements associated therewith. For instance, the license component 102 can generate a root license for a presentation with three elements that require root-bound leaf licenses. The verify component 202 can ensure that the necessary licenses have been generated and the appropriate binding is employed.

The license component 102 can further include a manager component 204 that can administrate the creation of root licenses based on collected data, media, content, presentations, etc. in order to provide the protected media 104. The manager component 204 can facilitate creating the root license for media, presentations, content, etc. based on the identified elements (e.g. a portion of audio, a portion of video, a graphic, a portion of a text, a portion of an application, a portion of data related to a presentation, a portion of a presentation, a portion of a packaged media, etc.). In particular, the manager component 204 can receive data via the interface 106, wherein such data can identify specific elements that can be packaged as at least one of media, content, presentation, data, etc. With the elements identified, the system 200 can generate the appropriate leaf licenses for elements such that the leaf licenses can be bound to a root license for the package (e.g., media, content, presentation, data, etc. including most any necessary elements). In another example, the manager component 204 can implement most any suitable user interface (UI) and/or graphical user interface (GUI) to assist in identifying elements and/or creating a root license with bound leaf licenses for media/content/presentations with respective elements.

The protected media 104 can be utilized by a media component 206. The media component 206 can be software, hardware, and/or any combination thereof that can utilize media, content, presentation, data, etc. Specifically, the media component 206 can play protected media 104 including corresponding elements (e.g., a portion of audio, a portion of video, a graphic, a portion of a text, a portion of an application, a portion of data related to a presentation, a portion of a presentation, a portion of a packaged media, etc.). For example, the media component 206 can be a portion of software that can receive the protected media 104 and plays the protected media upon verification of the license(s). In particular, the media component 206 can decrypt any portion of the protected media 104 based at least in part upon the license (e.g., root license and any corresponding leaf license). For instance, the media component 206 can utilize a display component (not shown) that facilitates displaying the protected media 104. It is to be appreciated that the display component can be any suitable display and/or screen such as, but not limited to, a monitor, a liquid crystal display (LCD), a plasma screen, a cathode ray tube (CRT) screen, a flat-screen, a television, a digital micro-mirror component, and/or any suitable component that can display data.

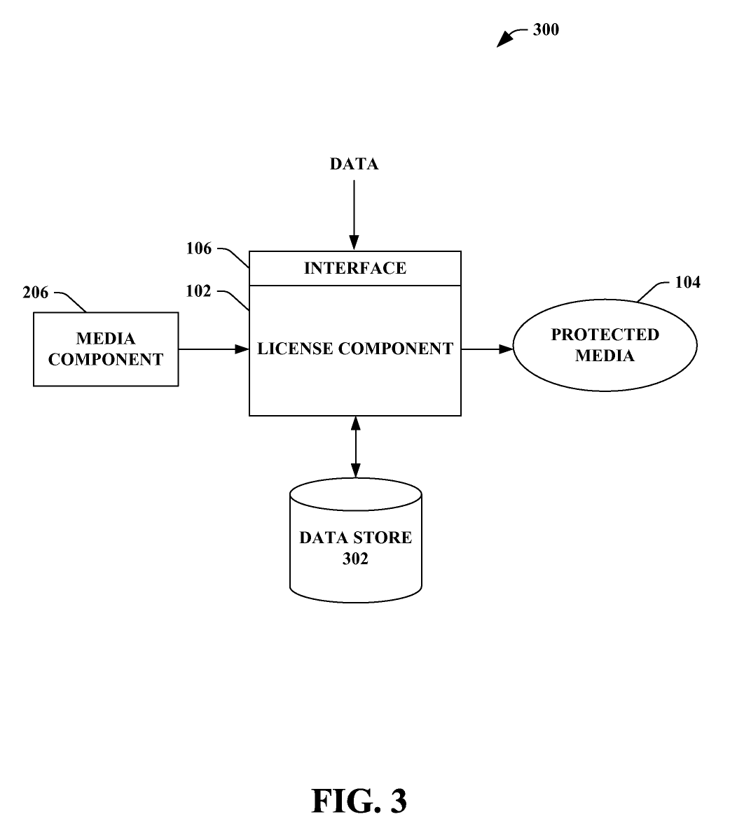

FIG. 3 illustrates a system 300 that facilitates binding a leaf license to a root license for a presentation, content, media, data, etc. and respective element of such presentation, content, media, data, etc. The system 300 can include the license component 102 that can associate a root license to media/content/data/presentation and a leaf license for at least one element corresponding to the media/content/data/presentation, wherein the leaf license can be bound to the root license. By implementing a root license and respective leaf licenses, the license component 102 can provide protected media 104 for most any data received via the interface 106. It is to be appreciated that the data received can be most any suitable data related to media, content, and/or presentation having at least one element (e.g., a portion of audio, a portion of video, a graphic, a portion of a text, a portion of an application, a portion of data related to a presentation, a portion of a presentation, a portion of a packaged media, etc.). By providing such protection employing a root license and at least one leaf license, the media component 206 can utilize the licenses in order to decrypt and play/utilize such media, content, presentations, data, etc.

The system 300 can further include a data store 302 that can include any suitable data related to the license component 102, and the protected media 104. The data store 302 can provide storage for most any suitable data related to the system 300, wherein such data can be utilized to mix and match to create packaged media, content, presentations, etc. having at least one element associated therewith. Moreover, the data store 302 can provide storage for at least one element that can correspond to at least one of the media, presentation, content, data, etc. For instance, the data store can include received data via the interface 106, media, presentations, content, data related to audio, data related to video, a portion of audio, a portion of video, a graphic, a character, a text, an element, a portion of an element, an audio/video (A/V) file, a portion of an application, a portion of software, most any suitable data related to media, etc.

It is to be appreciated that the data store 302 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 302 of the subject systems and methods is intended to comprise, without being limited to, these and any other suitable types of memory. In addition, it is to be appreciated that the data store 302 can be a server, a database, a hard drive, and the like.

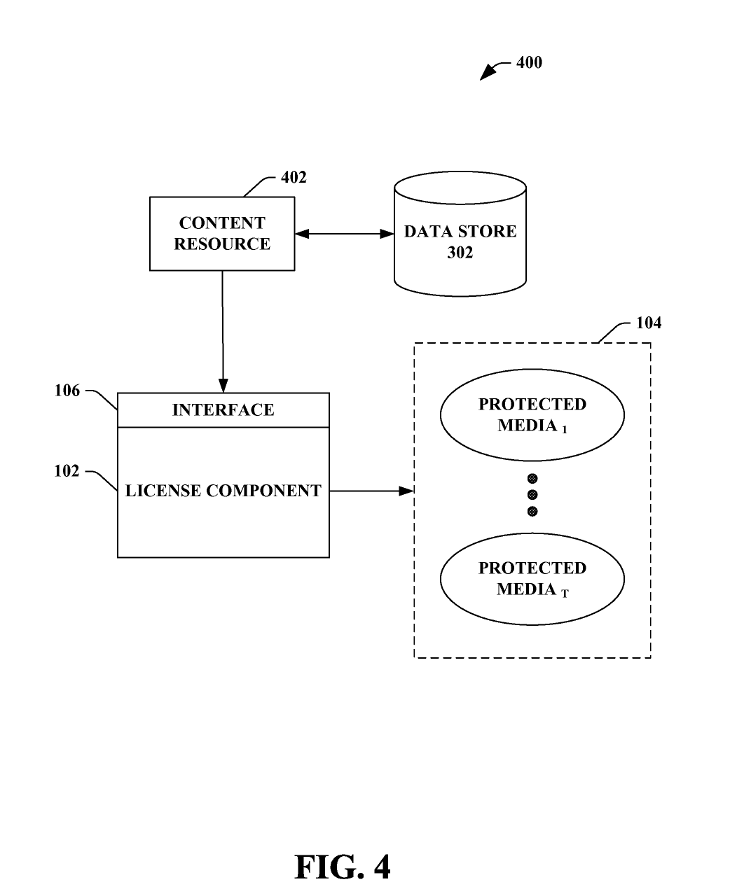

FIG. 4 illustrates a system 400 that facilitates creating protected media presentations with elements utilizing a root license and a bound leaf license. The system 400 can include the license component 102 that can provide protected media 104 based on received media, presentations, content, data, etc. The license component 102 can receive data (e.g., media, presentation, content, etc.) via the interface 106, wherein the license component 102 can generate a root license for a portion of the data (e.g., media, presentation, content, etc.) and a leaf license bound to the root license for each element (e.g., a portion of audio, a portion of video, a graphic, a portion of a text, a portion of an application, a portion of data related to a presentation, a portion of a presentation, a portion of a packaged media, etc.) related to the data. It is to be appreciated that the license component 102 can generate most any suitable number of root licenses and most any suitable number of leaf licenses based at least in part upon the amount of packaged data and respective number of elements related thereto. Moreover, it is to be appreciated that the system 400 can provide most any suitable number of protected media 104 such as protected media₁ to protected media_{T}, where T is a positive integer.

The license component 102 can receive data via the interface 106 such that the data received can be provided by a content resource 402. The license component 102 can received data in which to provide root license(s) and corresponding leaf license(s) from the content resource 402. The content resource 402 can provide at least a portion of data to be protected with at least one root license and at least one bound leaf license. It is to be appreciated that the content resource 402 can be at least one of a content provider, a third-party, a service, a third-party service, a vendor, a manufacturer, a content-maker, a company, a web-service, a website, a database, an email, a data store, a local service, a remote party, most any suitable entity that can provide a portion of at least one of media, presentation, content, etc., an advertising agency, a media company, and/or most any suitable technique that can identify portions of data that can be protected. For example, the content resource 402 can be an advertising agency that can identify data from the data store 302, wherein the data can be media/content/presentation including a first element and a second element. The license component 102 can receive the media/content/presentation and generate a root license for the media, a leaf license for the first element, and a leaf license for the second element such that the leaf licenses are bound to the root license to provide protection.

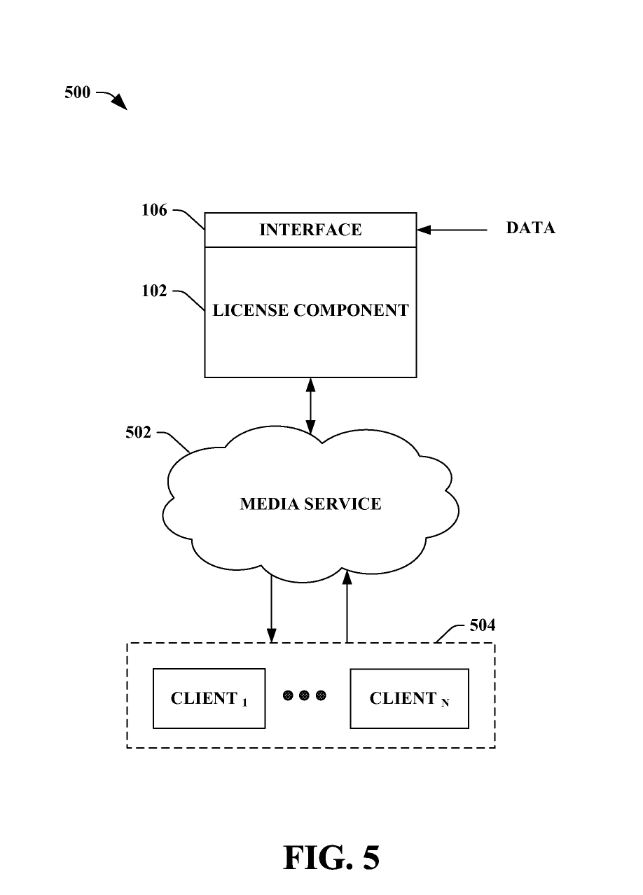

FIG. 5 illustrates a system 500 that facilitates employing a media service to provide protected media to a client. The system 500 can include the license component 102 that can create at least one root license and a corresponding leaf license for data received via the interface 106. The license component 102 can provide protected media, presentations, content, data, etc. and respective elements associated therewith. It is to be appreciated that the data received can be most any suitable data related to media, content, and/or presentation having at least one element (e.g., a portion of audio, a portion of video, a graphic, a portion of a text, a portion of an application, a portion of data related to a presentation, a portion of a presentation, a portion of a packaged media, etc.).

The system 500 can further include a media service 502 that can facilitate distributing protected media to at least one client 504. The media service 502 can deliver the data protected by the license component 102 to most any suitable client 504. It is to be appreciated that the media service 502 can allow access to the protected data (e.g., data protected by the license component 102 with at least one root license and at least one leaf license bound thereto) for most any suitable number of clients 504 such as client i to client N, where N is a positive integer. Moreover, it is to be appreciated and understood that the media service 502 can further provide sales in relation to purchasing and/or utilizing protected media. For instant, the media service 502 can provide the implementation of protected media based on one of the following: a per use basis (e.g., time logged on, amount utilized, etc.); a time-period basis (e.g., monthly fee, weekly fee, yearly fee, etc.); a per content/media basis (e.g., per utilized data, etc.), etc.

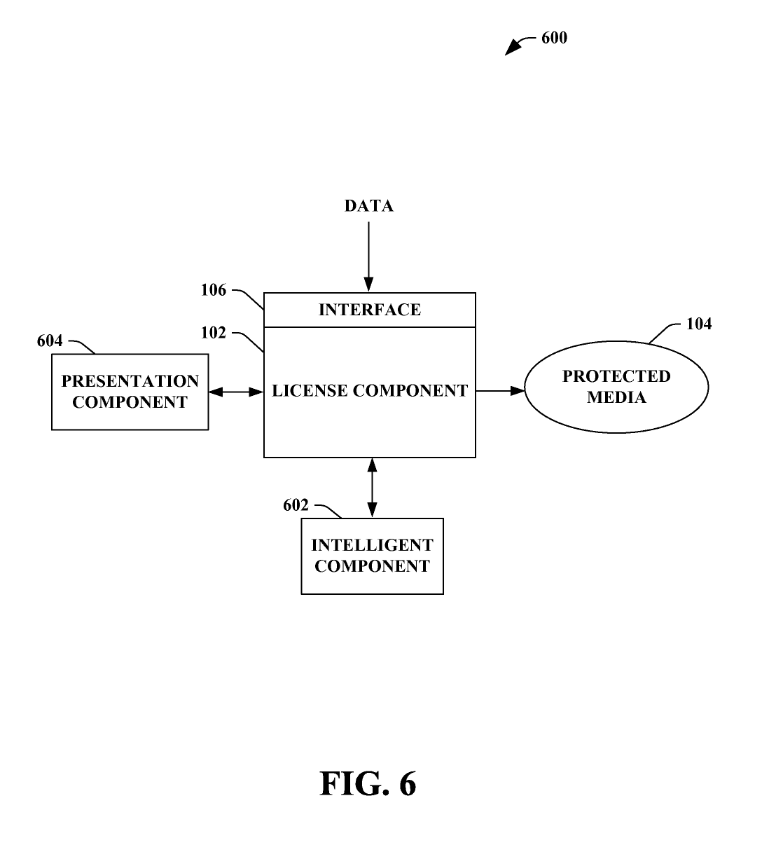

FIG. 6 illustrates a system 600 that employs intelligence to facilitate ensuring protection for a portion of media utilizing a root license and at least one leaf license. The system 600 can include the license component 102, the protected media 104, and the interface 106, wherein it is to be appreciated that the license component 102, the protected media 104, and the interface 106 can be substantially similar to respective components, media, and interfaces described in previous figures. The system 600 further includes an intelligent component 602. The intelligent component 602 can be utilized by the license component 102 to facilitate protecting media/content/presentations having at least one element employing a root license and at least one leaf license. For example, the intelligent component 602 can infer root licenses, leaf licenses, binding, element identification, media, content, presentations, data, media component settings, configurations for protected media, user settings, passwords, play lists, content resource configurations, distribution settings, client settings, services, license protection requirements, etc.

It is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The license component 102 can further utilize a presentation component 604 that provides various types of user interfaces to facilitate interaction between a user and any component coupled to the license component 102. As depicted, the presentation component 604 is a separate entity that can be utilized with the license component 102. However, it is to be appreciated that the presentation component 604 and/or similar view components can be incorporated into the license component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the license component 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

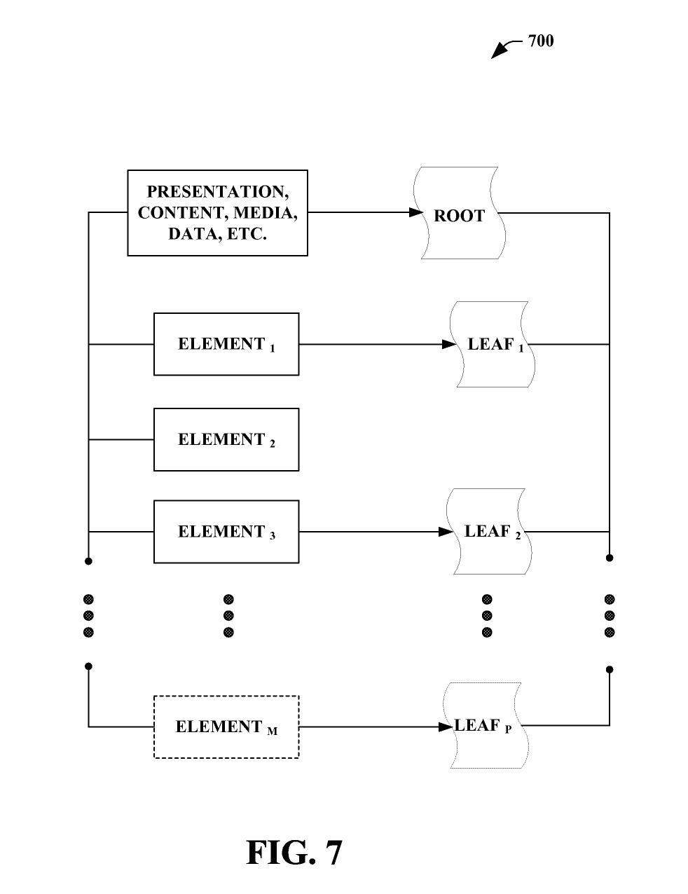

FIG. 7 illustrates a presentation, content, media, data, etc. 700 with an element that provides licensing protection employing a root license and a bound leaf license. The presentation, content, media, data, etc. 700 can include one or more independent elements. The presentation, content, media, data, etc. 700 can be any suitable data such as, but not limited to, media, content, presentations, a portion of data having an element (e.g. at least one of a portion of audio, a portion of video, a graphic, a portion of a text, a portion of an application, a portion of data related to a presentation, a portion of a presentation, a presentation, and/or a packaged media). It is to be appreciated that the presentation, content, media, data, etc. 700 and each element can be most any suitable file format. Moreover, the elements associated with the presentation, content, media, data, etc. 700 can include audio, video, graphics, text, applications, etc. In addition, an element can have a value outside context of the presentation 700. In one example, the presentation, content, media, data, etc. 700 can be interpreted by a presentation runtime. The presentation runtime can interact with Digital Rights Management (DRM) runtime to enable the enforcement policies required by a presentation publisher.

The claimed innovation can provide protection for the presentation 700. The presentation protection can utilize a root license for the presentation, content, media, data, etc. 700 and leaf licenses for each element. In addition, the leaf licenses are bound to the root license. The presentation, content, media, data, etc. 700 can include most any suitable number of elements such as element 1 to element M, where M is a positive integer. In addition, there can be most any suitable leaf licenses associated with the elements such as leaf license 1 to leaf license P, where P is a positive integer. The elements associated with the presentation, content, media, data, etc. 700 may not have a leaf license based on protection requirement (e.g., an element may be not copyrighted, etc.).

For instance, the presentation, content, media, data, etc. 700 can have three (3) elements. In this example, the Element 1 and the Element 2 can require protection, whereas the Element 2 does not. The presentation, content, media, data, etc. 700 can reference a root license that can be associated with Element 1, Element 2, and Element 3. Moreover, Element 1 can reference a leaf license 1 and Element 3 can reference a leaf license 2 since both require protection. With the presentation protection and root licenses and/or leaf licenses, leaf license 1 and leaf license 2 are leaf licenses for the Root license. An application, media component (discussed supra), a portion of software, etc. can use leaf license 1 and leaf license 2 since it can understand and/or enforce a policy included with the root license.

It is to be appreciated that the presentation runtime can get at least one policy from number of different sources such as, but not limited to, a leaf license, a root license, a presentation, etc. The presentation runtime can define a way for storing presentation wide policies. For instance, a presentation runtime can choose to store policies in the leaf licenses. In another example, leaf license 2 can include a “No Skip” policy. The presentation runtime can open the presentation, content, media, data, etc. 700. With Element 1 being the first element, the presentation runtime can load a license for Element 1 to discover and/or enforce the “No Skip” policy, wherein the enforcement can include disabling a skip button in a user interface (UI). However, there are two problems with this approach: 1) An attacker can exclude Element 1 from the presentation; and 2) Complex policies can be hard to define such as “Allow skip only if user played through the previous element.”

In order to account and solve the problems with the above approaches, the presentation, content, media, data, etc. 700 can be protected from modification. For instance, the presentation, content, media, data, etc. 700 can be protected from modification by using at least one of an encryption and/or a signature. The presentation runtime can verify (e.g., at a start time or continuously) that the presentation signature/encryption matches content of the presentation. For instance, signature/encryption can be stored in the presentation itself or in the Root license. Moreover, if an attacker cannot tamper with the presentation, content, media, data, etc. 700, the logic to enforce complex policies can be embedded into the presentation itself. Presentation runtime can use APIs exposed by DRM runtime to persist presentation state in the DRM protected storage and/or perform metering.

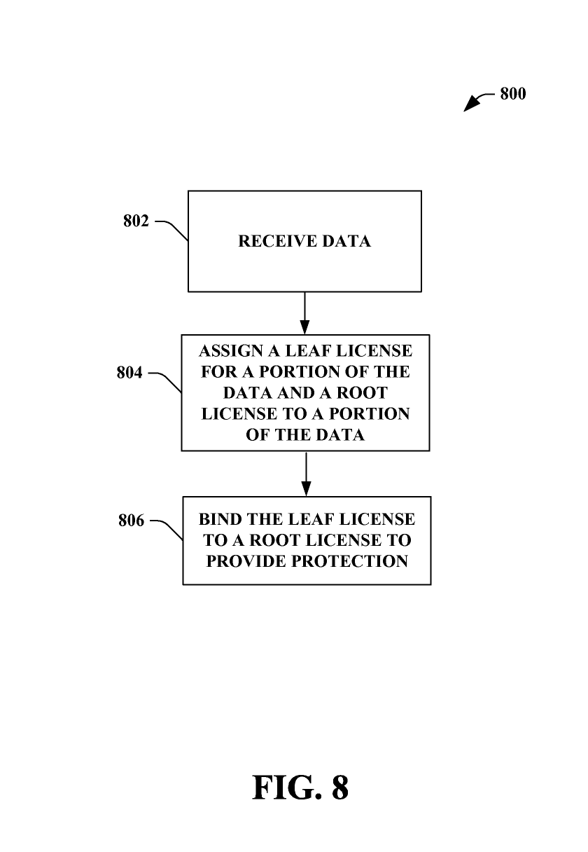

FIGS. 8-10 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 8 illustrates a methodology 800 for ensuring protection for a portion of media utilizing a root license and at least one leaf license. At reference numeral 802, data can be received. The data can be, but is not limited to, most any suitable data related to media, content, presentation, and/or most any suitable data including at least one element (e.g. a portion of audio, a portion of video, a graphic, a portion of a text, a portion of an application, a portion of data related to a presentation, a portion of a presentation, a portion of a packaged media, etc.). For example, the data received can be most any suitable data that includes a portion of media, content, presentation, etc. that may require protection and/or licensing.

At reference numeral 804, a leaf license and a root license can be assigned to a portion of the received data. The data can be received and protected by assigning a leaf license to most any portion of element associated with the data that requires protection. Moreover a collection of elements related to the data can be packaged and/or assigned a root license. At reference numeral 806, the at least one leaf license can be bound to the at least one root license to ensure protection. In other words, the data received can be assigned a leaf license for each element associated therewith and a collection of elements (e.g., the received data) can correspond to a root license. The root license and/or corresponding leaf license(s) can include a policy that can be enforced which in turn allows the data to be protected.

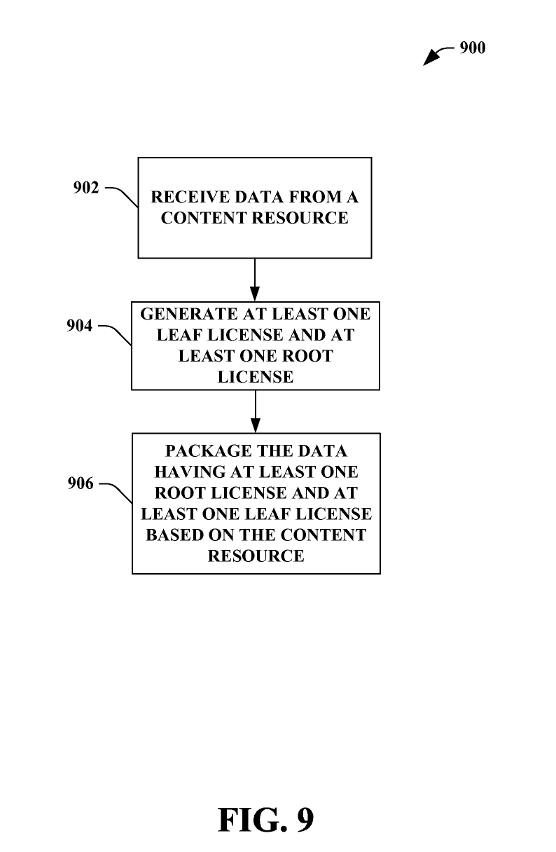

FIG. 9 illustrates a methodology 900 for generating universal licensed media with a leaf license bound to a root license. At reference numeral 902, data can be received from a content resource. The content resource can provide at least a portion of data to be protected with at least one root license and at least one bound leaf license. It is to be appreciated that the content resource can be at least one of a content provider, a third-party, a service, a third-party service, a vendor, a manufacturer, a content-maker, a company, a web-service, a website, a database, an email, a data store, a local service, a remote party, most any suitable entity that can provide a portion of at least one of media, presentation, content, etc., an advertising agency, a media company, and/or most any suitable technique that can identify portions of data that can be protected.

At reference numeral 904, at least one leaf license and at least one root license can be generated. Specifically, the root license can be generated for received data. Moreover, the leaf license can be generated for a portion of the data, such as an element (e.g., a portion of audio, a portion of video, a graphic, a portion of a text, a portion of an application, a portion of data related to a presentation, a portion of a presentation, a portion of a packaged media, etc.). In addition, at least one of the leaf license and/or the root license can include a policy that can be enforced upon utilization of the protected data.

At reference numeral 906, the data can be packaged having at least one root license and at least one leaf license based on the content resource. In particular, the content resource can identify portions of data, wherein each portion of data can require protection with specific and respective policies that can be enforced. Thus, the content resource can identify portions of data, protections/policies associated to the portions of data, and/or the specifics of the portions of data in the manner to be packaged (e.g., binding the leaf licenses to specific root licenses). In one example, the packaged data can be delivered based at least in part upon such data being protected and policies are ensured.

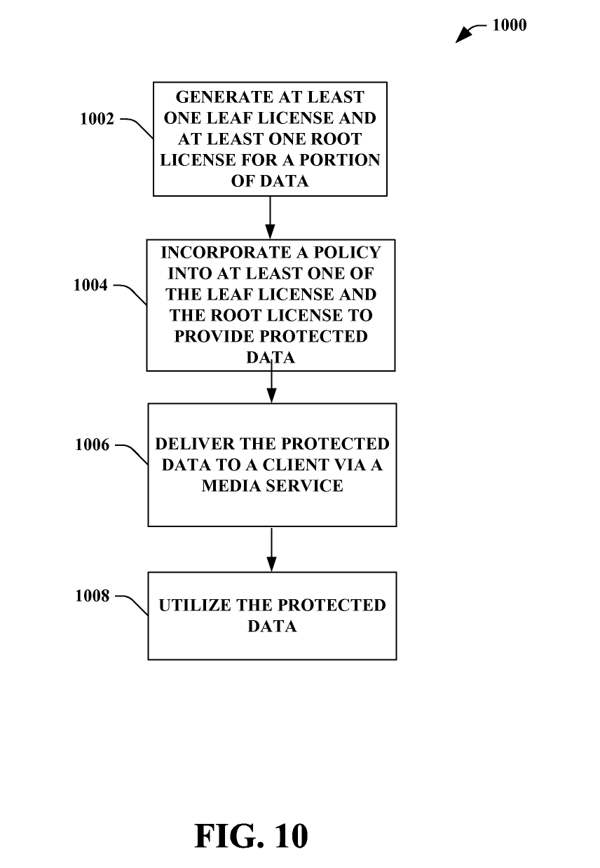

FIG. 10 illustrates a methodology 1000 that facilitates utilizing a portion of protected media having a root license and at least one leaf license. At reference numeral 1002, at least one leaf license and at least one root license can be generated for a portion of data. The data can be, but is not limited to, most any suitable data related to media, content, presentation, and/or most any suitable data including at least one element (e.g. a portion of audio, a portion of video, a graphic, a portion of a text, a portion of an application, a portion of data related to a presentation, a portion of a presentation, a portion of a packaged media, etc.). At reference numeral 1004, a policy can be incorporated into at least one of the leaf license and/or the root license to provide protected data. Based on incorporating at least one policy into the root license and/or leaf license, specific enforcements can be employed. For example, the policy can be a restriction on manipulation of the data, implementation requirements (e.g. play back, no fast forward, etc.), etc.

At reference numeral 1006, the protected data can be delivered to a client via a media service. The media service can distribute the protected data based on a plurality of techniques. For example, the media service can provide the implementation of protected data based on one of the following: a per use basis (e.g., time logged on, amount utilized, etc.); a time-period basis (e.g., monthly fee, weekly fee, yearly fee, etc.); a per content/media basis (e.g., per utilized data, etc.), etc. At reference numeral 1008, the protected data can be utilized. For example, the data can be utilized by a media component (discussed supra).

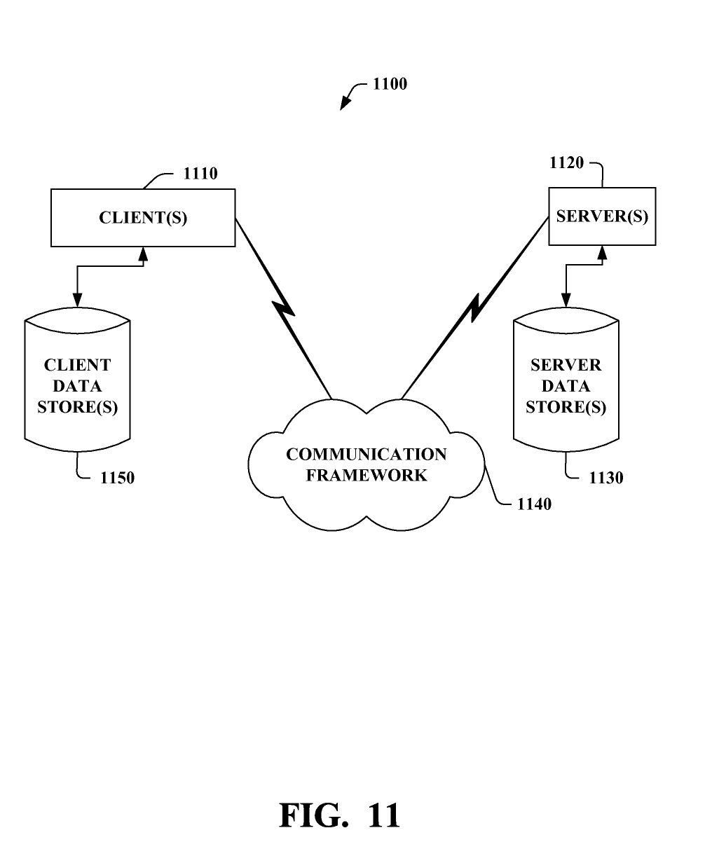

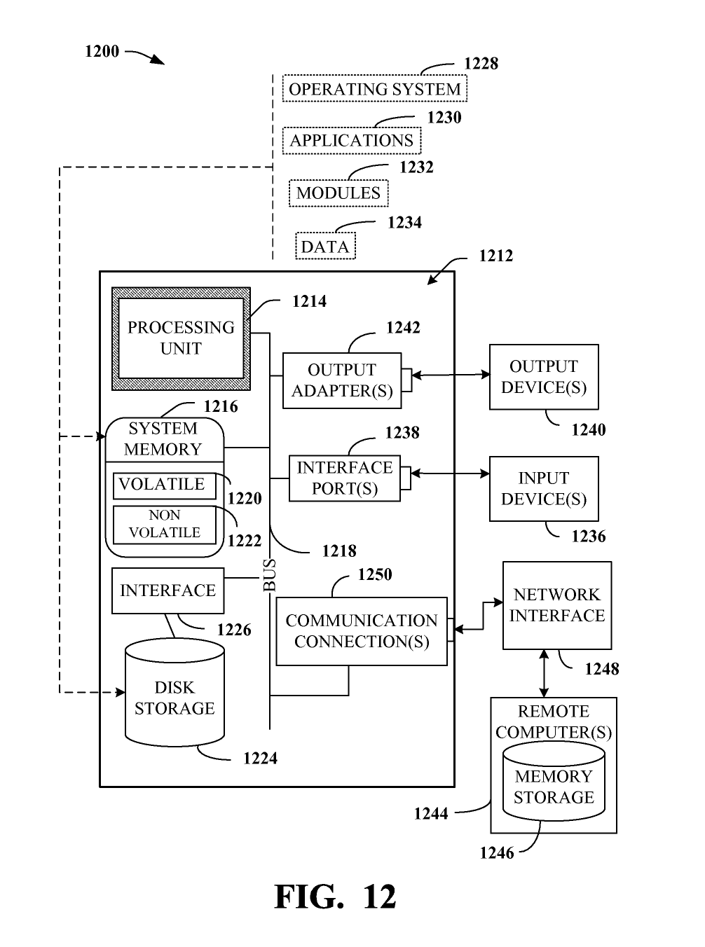

In order to provide additional context for implementing various aspects of the claimed subject matter, FIGS. 11-12 and the following discussion is intended to provide a brief, general description of a suitable computing environment in which the various aspects of the subject innovation may be implemented. For example, a license component can bind at least one leaf license to a root license to protect media/presentation/content/data and corresponding elements of the media/presentation/content/data, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 11 is a schematic block diagram of a sample-computing environment 1100 with which the claimed subject matter can interact. The system 1100 includes one or more client(s) 1110. The client(s) 1110 can be hardware and/or software (e.g., threads, processes, computing devices). The system 1100 also includes one or more server(s) 1120. The server(s) 1120 can be hardware and/or software (e.g., threads, processes, computing devices). The servers 1120 can house threads to perform transformations by employing the subject innovation, for example.

One possible communication between a client 1110 and a server 1120 can be in the form of a data packet adapted to be transmitted between two or more computer processes. The system 1100 includes a communication framework 1140 that can be employed to facilitate communications between the client(s) 1110 and the server(s) 1120. The client(s) 1110 are operably connected to one or more client data store(s) 1140 that can be employed to store information local to the client(s) 1110. Similarly, the server(s) 1120 are operably connected to one or more server data store(s) 1130 that can be employed to store information local to the servers 1120.

With reference to FIG. 12, an exemplary environment 1200 for implementing various aspects of the claimed subject matter includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable programmable ROM (EEPROM), or flash memory. Volatile memory 1220 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in the suitable operating environment 1200. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the claimed subject matter can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates ensuring media integrity, comprising:
an interface component that receives at least one of media, content, data, or presentation with at least one element; and
a license component that associates a root license to the at least one of media, content, data, or presentation and a leaf license to at least one element, the leaf license is bound to the root license to ensure the at least one of media, content, data, or presentation and the at least one element include license protection.

2. The system of claim 1, the element is at least one of a portion of audio, a portion of video, a graphic, a portion of a text, a portion of an application, a portion of data related to a presentation, a portion of a presentation, or a packaged media.

3. The system of claim 1, the at least one of media, content, data, or presentation includes an element that is non-licensed.

4. The system of claim 1, further comprising a verify component that implements a redundancy-check in order to identify which portions of at least one of media, content, data, or presentation received requires license protection with at least one of the root license or the leaf license.

5. The system of claim 1, further comprising a manager component that administrates the association of the root license and the leaf license to ensure the at least one of media, content, data, or presentation and respective element are protected accordingly.

6. The system of claim 1, further comprising a media component that utilizes the at least one of media, content, data, or presentation with the root license and corresponding element with leaf license.

7. The system of claim 6, the media component decrypts a portion of the at least one of media, content, data, or presentation based at least in part upon one of the root license or the leaf license.

8. The system of claim 1, the at least one of media, content, data, or presentation is at least one of a portion of data related to audio, a portion of data related to video, a portion of data, a portion of content, a portion of a presentation, or a portion of data that can be protected.

9. The system of claim 8, further comprising a presentation runtime that interprets at least one of media, content, data, presentation, or the element.

10. The system of claim 9, the presentation runtime interacts with a Digital Rights Management (DRM) runtime to enable an enforcement policy required by a publisher of the at least one of media, content, data, or presentation.

11. The system of claim 10, further comprising a component that interprets the enforcement policy, the component must understand the root license and at least one of the leaf license.

12. The system of claim 1, the license component implements at least one of an encryption or a signature for the root license to ensure protection of the at least one of media, content, data, or presentation, at least one of the signature or the encryption matches a portion of the at least one of media, content, data, or presentation.

13. The system of claim 12, at least one of the signature or the encryption is incorporated into at least one of the media, content, data, presentation, the root license, or the leaf license.

14. The system of claim 1, further comprising a content resource that provides a portion of the at least one of media, content, data, or presentation to be protected, the content resource is at least one of a content provider, a third-party, a service, a third-party service, a vendor, a manufacturer, a content-maker, a company, a web-service, a website, a database, an email, a data store, a local service, a remote party, an advertising agency, a media company, or a technique that identifies a portion of data that can be protected.

15. A computer-implemented method that facilitates ensuring data integrity, comprising:
receiving data having at least one element associated therewith;
assigning a root license for a portion of the data;
assigning a leaf license for a portion of the element; and
binding the leaf license to the root license to provide protection.

16. The method of claim 15, further comprising the element is at least one of audio, a portion of video, a graphic, a portion of a text, a portion of an application, a portion of data related to a presentation, a portion of a presentation, a presentation, or a packaged media.

17. The method of claim 15, further comprising:
receiving the data from a content resource; and
packaging the data having the root license and corresponding leaf license based on the content resource, the content resource is a content provider, a third-party, a service, a third-party service, a vendor, a manufacturer, a content-maker, a company, a web-service, a website, a database, an email, a data store, a local service, a remote party, an advertising agency, a media company, or a technique that identifies a portion of data that can be protected.

18. The method of claim 15, further comprising incorporating a policy into at least one of the root license, the leaf license, or the data.

19. The method of claim 18, further comprising:
employing a media service to deliver the protected data to at least one client; and
utilizing the protected data based on the incorporated policy.

20. A computer-implemented system that facilitates providing data protection, comprising:
means for receiving data with at least one element, the element is at least one of a portion of audio, a portion of video, a graphic, a portion of a text, a portion of an application, a portion of data related to a presentation, a portion of a presentation, a presentation, or a packaged media; and
means for assigning a root license to the data and a leaf license to at least one element, the leaf license is bound to the root license to ensure the data and the at least one element include license protection.
